(19) United States
(12) Patent Application Publication
(10) Pub. No.: US 2025/0320359 A1
(43) Pub. Date: Oct. 16, 2025

(54) COMPOUNDING COMPOSITION APPLIED TO THE AIR CUTOFF VALVE FOR FUEL CELL VEHICLE

(71) Applicants: Hyundai Motor Company, Seoul (KR); Kia Corporation, Seoul (KR); LG Chem, Ltd., Seoul (KR)

(72) Inventors: Min Gyun Chung, Seoul (KR); Hyeong Won Park, Hwaseong (KR); Ik Hwan Cho, Daejeon (KR); Hye Seung Ham, Daejeon (KR); Jae Chan Park, Daejeon (KR); In Seok Seo, Daejeon (KR)

(21) Appl. No.: 18/812,297

(22) Filed: Aug. 22, 2024

(30) Foreign Application Priority Data
Apr. 16, 2024 (KR) 10-2024-0050727

(51) Int. Cl. C08L 71/12; B29B 7/00; B29B 7/42; B29B 7/72; B29B 9/06; B29K 25/00; B29K 71/00; B29K 105/00; B29K 105/16; B29K 509/08; C08J 3/20; C08K 9/04; C08K 9/06; C08L 25/06

(52) U.S. Cl. CPC C08L 71/12; B29B 7/007; B29B 7/42; B29B 7/72; B29B 9/06; C08J 3/201; C08K 9/04; C08K 9/06; C08L 25/06; B29K 2025/06; B29K 2071/00; B29K 2105/0094; B29K 2105/16; B29K 2509/08; B29K 2995/0012; B29K 2995/0077; B29K 2995/0089; B29K 2995/0093; C08J 2325/06; C08J 2371/12; C08J 2425/06; C08J 2425/08; C08J 2471/12; C08K 2201/003; C08K 2201/004; C08L 2203/30; C08L 2205/025; C08L 2205/03

(57) ABSTRACT

Provided is a thermoplastic resin composition comprising about 50 wt % to about 70 wt % of a base resin consisting of polyarylene ether resin and polystyrene resin in a ratio from about 4:6 to about 6:4, about 20 wt % to about 40 wt % of glass fiber with a sizing agent, about 1 wt % to about 5 wt % of an adhesion promoter or a multifunctional reactive agent, about 0 wt % to about 10 wt % of an impact modifier, and about 0.1 wt % to about 1.0 wt % of a hydrophobic additive, with wt % based on the total weight. The composition exhibits high tensile strength, impact strength, heat deflection temperature, and low cation leaching. Additionally, a method for preparing the composition involves melt-kneading the raw materials and extruding the mixture using an extruder with specific parameters, ensuring a controlled and efficient production process.

### CROSS-REFERENCE TO RELATED APPLICATION

This application claims, under 35 U.S.C. § 119 (a), the benefit of Korean Patent Application No. 10-2024-0050727, filed on Apr. 16, 2024, the entire contents of which are incorporated herein by reference.

### BACKGROUND

### Technical Field

The present disclosure relates to thermoplastic resin compositions and methods for their preparation. Specifically, it pertains to high-performance thermoplastic resin compositions that include a combination of polyarylene ether resin, polystyrene resin, glass fiber, adhesion promoters, impact modifiers, and hydrophobic additives. These compositions are particularly suited for applications requiring high tensile strength, impact resistance, heat resistance, and minimal cation leaching, such as in automotive, electrical, and electronic industries. The disclosure also includes methods for manufacturing these compositions using melt-kneading and extrusion techniques.

### Background

A fuel cell system is a battery system applied to hydrogen fuel cell vehicles, which are environmentally friendly future vehicles, and the fuel cell system includes a fuel cell stack configured to generate electrical energy by electrochemical reaction of reactive gas, a hydrogen processing system configured to supply hydrogen as a fuel, an air processing system configured to supply air containing oxygen, and a heat management system configured to control the operating temperature of the fuel cell stack by releasing heat, which is a reaction byproduct, to the outside.

An air cutoff valve (ACV) for fuel cell vehicles is one of the parts of the air processing system. In an ACV, air from outside the fuel cell system is introduced in a high temperature and high humidity state into the fuel cell stack through an air compressor, an air cooler, a humidifier, and an ACV. If air may always be injected into the fuel cell stack, a voltage is generated by residual hydrogen, etc., which deteriorates durability of the fuel cell stack, so the ACV functions to control air injection.

In particular, when cations are leached in the air supplied to the fuel cell stack, they bind to the sulfonic acid group (SO³⁻) present in a fuel cell stack membrane and a catalyst layer ionomer, lowering hydrogen ion conductivity and decreasing hydrophobicity of the catalyst layer/gas diffusion layer (GDL). Hence, leaching of cations in the air supplied to the fuel cell stack must be minimized.

Since a valve cover for ACVs is the final part located right before the hot and humid air that has passed through various parts of the air processing system is supplied to the fuel cell stack, it is necessary to design the material thereof to minimize cation leaching. Also, since a door configured to control the on/off of air in the valve cover is opened and closed repeatedly, dimensional changes of the parts must be very small in a high temperature and high humidity environment.

A conventional valve cover for ACVs is generally made of an aluminum casting material, but is problematic in that it is difficult to reduce weight and the cost is high. Accordingly, there is an urgent need to develop low-leaching materials while making materials lighter and reducing costs.

### SUMMARY OF THE DISCLOSURE

The present disclosure has been made keeping in mind the problems encountered in the related art, and an object of the present disclosure is to provide a plastic-based compounding composition including polyarylene ether resin, polystyrene resin, and glass fiber, enabling material weight reduction and cost reduction and exhibiting dimensional stability and reduced cation leaching.

Another object of the present disclosure is to provide a method of preparing a compounding composition including mixing a base resin including polyarylene ether resin and polystyrene resin, glass fiber, and an adhesion promoter and then extruding the mixture.

The objects of the present disclosure are not limited to the foregoing. The objects of the present disclosure will be able to be clearly understood through the following description and to be realized by the means described in the claims and combinations thereof.

In some embodiments, a thermoplastic resin composition comprises about 50 wt % to about 70 wt % of a base resin comprising polyarylene ether resin and polystyrene resin in a ratio from about 4:6 to about 6:4, about 20 wt % to about 40 wt % of glass fiber comprising a sizing agent, about 1 wt % to about 5 wt % of an adhesion promoter or a multifunctional reactive agent, about 0 wt % to about 10 wt % of an impact modifier, and about 0.1 wt % to about 1.0 wt % of a hydrophobic additive, with wt % based on the total weight of the thermoplastic resin composition.

In some embodiments, the polyarylene ether resin has an intrinsic viscosity of about 0.2 dl/g to about 0.8 dl/g, and the polystyrene resin is general-purpose polystyrene (GPPS). The glass fiber comprises an average diameter from about 3 μm to about 25 μm, and an average length from about 1 mm to about 15 mm. The glass fiber is surface-modified with a sizing agent comprising at least one selected from an amino silane-based compound, a urethane compound, an epoxy silane-based compound, and combinations thereof. The adhesion promoter comprises fumaric acid-modified polyarylene ether, and the impact modifier comprises a styrene-based copolymer. The hydrophobic additive comprises at least one selected from a nucleating agent, a lubricant, an antioxidant, and combinations thereof. The impact modifier and the hydrophobic additive do not comprise a metal component.

In some embodiments, the thermoplastic resin composition exhibits a tensile strength of about 110 MPa or more as measured according to ISO 527 testing standard, an Izod notch impact strength of about 8 KJ/m² or more as measured according to ISO 180 testing standard, a heat deflection temperature of about 120° C. or more as measured according to ISO 75/A (1.8MPa) testing standard, and cation leaching of about 5 ppm or less after immersion in deionized water under conditions of an area of about 270 cm², about 2 t, and about 80° C. for 168 hours.

The polyarylene ether resin may be selected from for example poly(2,6-dimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dimethoxy-1,4-phenylene ether), poly(2,6-di(chloromethyl)-1,4-phenylene ether), poly(2,6-di(bromomethyl)-1,4-phenylene ether), poly(2,6-diphenyl-1,4-phenylene ether), poly(2,6-dichloro-1,4-phenylene ether), poly(2,6-dibenzyl-1,4-phenylene ether), and poly(2,5-dimethyl-1,4-phenylene ether). In certain aspects, the polyarylene ether resin suitably may have a number average molecular weight of about 10,000 g/mol to about 100,000 g/mol. In certain aspects, the polystyrene resin has a flow index of about 2 g/10 min to about 20 g/10 min as measured at 200° C. under 5 kg according to ASTM D1238. In certain aspects, the glass fiber comprises silica (SiO₂) in a weight proportion of about 50% to about 70%. In certain aspects, the glass fiber suitably is surface-modified with a sizing agent comprising an amino silane-based compound or a urethane compound to improve wetting properties and mechanical strength.

The term polyarylene ether resin as referred to herein is used as and may include in the resin chain multiple optionally substituted aryl units including carboxylic aryl units e.g. phenyl, naphthyl that may be optionally substituted with keto, carbocylic acid, sulfono, nitrile, halogen, C1-6alkyl, and other moieties with oxygen (ether) linkages interposed between at least one of the aryl units.

In some embodiments, a method of preparing a thermoplastic resin composition involves melt-kneading a raw material to produce a melt-kneaded reaction mixture and extruding the melt-kneaded reaction mixture. The raw material comprises from about 50 wt % to about 70 wt % of a base resin comprising polyarylene ether resin and polystyrene resin in a ratio from about 4:6 to about 6:4, about 20 wt % to about 40 wt % of glass fiber comprising a sizing agent, about 1 wt % to about 5 wt % of an adhesion promoter or a multifunctional reactive agent, about 0 wt % to about 10 wt % of an impact modifier, and about 0.1 wt % to about 1.0 wt % of a hydrophobic additive. The melt-kneading and extruding processes are performed using an extruder with 9 or more kneading blocks. The extruder comprises a main hopper and an extruder cylinder, wherein the main hopper is configured to supply a raw material to the extruder cylinder. The extruder cylinder comprises a screw and is configured to communicate between the main hopper and a discharge die so that the raw material added to the main hopper flows to the discharge die and is melt-kneaded into a reaction mixture. The discharge die is configured to discharge the melt-kneaded reaction mixture from the extruder. The barrel temperature of the extruder cylinder is from about 230° C. to about 330° C., and the rotation speed of the screw is from about 100 rpm to about 500 rpm. The extruder cylinder further comprises a side feeder configured to supply an auxiliary raw material to the extruder cylinder. The method further includes cooling the extruded melt-kneaded reaction mixture to form solid pellets. The extruder is configured to discharge the melt-kneaded reaction mixture at a controlled rate to ensure uniformity of the final product.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows an ACV part including a valve cover to which a resin composition according to an embodiment of the present disclosure may be applied; and

FIG. 2 shows predicting long-term thermal aging properties according to Test Example of the present disclosure.

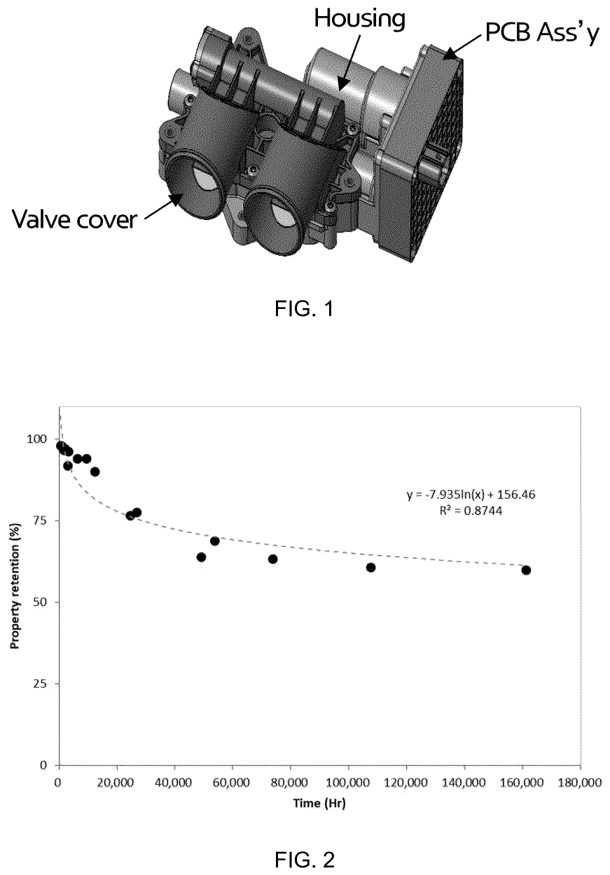

### DETAILED DESCRIPTION OF EMBODIMENTS

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

An embodiment of the present disclosure pertains to a thermoplastic resin composition including, based on the total weight of the thermoplastic resin composition, 50 wt % to 70 wt % of a base resin, 20 wt % to 40 wt % of glass fiber, 1 wt % to 5 wt % of an adhesion promoter or a multifunctional reactive agent, 0 wt % to 10 wt % of an impact modifier, and 0.1 wt % to 1.0 wt % of a hydrophobic additive.

The base resin may include polyarylene ether resin and polystyrene resin in a ratio of 4:6 to 6:4. When the amount of the polyarylene ether resin is increased, dimensional stability and moisture absorption resistance are superior due to the amorphous resin, but the crystallization temperature is high, so this resin is commonly used in a mixture with other resins. The base resin according to the present disclosure may achieve balance between hydrolysis resistance, property requirements, and injection moldability required for ACVs at the above resin mixing ratio.

The polyarylene ether resin may be a polyphenylene ether resin, and an example thereof may include, but is not limited to, at least one selected from the group consisting of poly(2,6-dimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dimethoxy-1,4-phenylene ether), poly(2,6-di(chloromethyl)-1,4-phenylene ether), poly(2,6-di(bromomethyl)-1,4-phenylene ether), poly(2,6-diphenyl-1,4-phenylene ether), poly(2,6-dichloro-1,4-phenylene ether), poly(2,6-dibenzyl-1,4-phenylene ether) and poly(2,5-dimethyl-1,4-phenylene ether).

The polyarylene ether resin has a number average molecular weight, for example, of 10,000 g/mol to 100,000 g/mol, preferably 10,000 g/mol to 70,000 g/mol, more preferably 15,000 g/mol to 45,000 g/mol. Within the above range, excellent processability and property balance are achieved. Also, the polyarylene ether resin may have an intrinsic viscosity of 0.2 dl/g to 0.8 dl/g, preferably 0.3 dl/g to 0.6 dl/g, more preferably 0.35 dl/g to 0.5 dl/g. Within the above range, it is possible to obtain fluidity suitable for molding while maintaining high mechanical properties such as impact strength, tensile strength, etc. of the composition, and compatibility with polystyrene resin is high.

The intrinsic viscosity of the polyarylene ether resin may be 0.2 dl/g to 0.8 dl/g.

The polystyrene resin may include at least one selected from the group consisting of general-purpose polystyrene (GPPS) and high-impact polystyrene (HIPS), and may include, for example, GPPS. High-impact polystyrene resin has superior processability, dimensional stability, and tensile strength. However, general-purpose polystyrene resin may contain fewer metal ions during preparation than high-impact polystyrene resin, so it is more suitable for the present disclosure. GPPS is a styrene homopolymer and refers to the most common resin polymerized with styrene as a monomer. GPPS is transparent but has a brittle property. It is HIPS that improves impact resistance by adding butadiene to GPPS.

In the present disclosure, the polystyrene resin has a flow index of 2 g/10 min to 20 g/10 min, preferably 3 g/10 min to 15 g/10 min, as measured at 200° C. under 5 kg according to ASTM D1238. Within the above range, superior processability and property balance are exhibited.

The base resin may be included in an amount of 50 wt % to 70 wt %, 50 wt % to 65 wt %, 55 wt % to 70 wt %, or 55 wt % to 60 wt %, based on the total weight of the composition, and may be included in an amount of, for example, 60 wt %.

The glass fiber preferably includes silica (SiO2) in a weight proportion of 50 to 70, more preferably in a weight proportion of 51 to 65, even more preferably in a weight proportion of 51 to 58, based on the total weight of the glass fiber. Within the above range, fluidity and impact strength are maintained, tensile strength, flexural strength, and flexural modulus are excellent, and heat resistance is further improved.

The glass fiber may have an average diameter of 3 to 25 μm, preferably 5 to 20 μm, more preferably 8 to 15 μm. If the average diameter of the glass fiber is less than 8 μm, an improvement in rigidity may be insufficient due to easy breakage of the glass fiber, whereas if it exceeds 15 μm, the properties may deteriorate due to a decrease in surface area and the problem of protrusion on the surface of a final product may occur, making it impossible to obtain good external appearance.

The average length of the glass fiber is 1 mm to 15 mm, preferably 2 mm to 7 mm, more preferably 2.5 mm to 5 mm. Within the above range, mechanical strength with the resin is improved and external appearance of the final product is also good. If the length of the glass fiber is less than 2 mm, an improvement in rigidity may be insufficient due to the short glass fiber, whereas if it exceeds 5 mm, rigidity may be improved, but good external appearance cannot be obtained due to the problem of protrusion on the surface.

The glass fiber may be surface-modified with a sizing agent including at least one selected from the group consisting of an amino silane-based compound, a urethane compound, and an epoxy silane-based compound, and for example, surface treatment with at least one selected from the group consisting of an amino silane-based compound and a urethane compound has the advantage of improving wetting properties between the base resin and the glass fiber and enhancing mechanical strength of the final product by dispersing the same evenly in the resin composition. More importantly, wetting properties are improved and cation leaching from glass fiber may be reduced by resisting water uptake to the interface between the resin and the glass fiber.

If the amount of the glass fiber is less than 20 wt % based on the total weight of the composition, the effect of improving a heat deflection temperature may be insignificant, whereas if it exceeds 40 wt %, cation leaching may increase, and valve cover roundness may be unsuitable for dimensional precision. Hence, the glass fiber is used in an amount satisfying the above range in the present disclosure.

The adhesion promoter may serve to enhance adhesion between the base resin and the glass fiber.

The functional group in the adhesion promoter has affinity for glass fiber, and the resin portion includes a material compatible with the base resin, and for example, fumaric acid-modified polyphenylene ether resin and styrene maleic acid copolymer may be used. As the adhesion promoter, fumaric acid-modified polyphenylene ether resin is more effective at reducing ion leaching. In relation to the role of the glass fiber, the adhesion promoter may contribute to improving wetting properties between the resin and the glass fiber and to maximizing reduction of ion leaching from the glass fiber by resisting water uptake to the interface between the resin and the glass fiber.

The multifunctional reactive agent may contain two or more functional groups selected from the group consisting of a carboxyl group, an amine group, a hydroxy group, a maleic acid group, and an epoxy group. The multifunctional reactive agent may be an epoxy resin, and for example, may be at least one selected from the group consisting of bisphenol A epoxy resin, hydrogenated bisphenol A epoxy resin, brominated bisphenol A epoxy resin, bisphenol F epoxy resin, bisphenol S epoxy resin, novolac epoxy resin, phenol novolac epoxy resin, cresol novolac epoxy resin, N-glycidyl epoxy resin, bisphenol A novolac epoxy resin, bixylenol epoxy resin, biphenol epoxy resin, chelate epoxy resin, glyoxal epoxy resin, amino group-containing epoxy resin, rubber-modified epoxy resin, dicyclopentadiene phenolic epoxy resin, diglycidyl phthalate resin, heterocyclic epoxy resin, tetraglycidylxylenoylethane resin, silicone-modified epoxy resin, and ε-caprolactone-modified epoxy resin, preferably at least one selected from among novolac epoxy resin, phenol novolac epoxy resin, and cresol novolac epoxy resin, more preferably cresol novolac epoxy resin. As such, all of mechanical properties such as tensile strength, impact strength, etc., insulating properties, heat resistance, and flame retardancy are superior.

The amount of the adhesion promoter or the multifunctional reactive agent may be 1 wt % to 5 wt % in the resin composition of the present disclosure, and the resin composition of the present disclosure may be improved in mechanical properties with an increase in the amount of the adhesion promoter or the multifunctional reactive agent, but it is difficult to confirm significant effects in an amount exceeding 5 wt %.

The impact modifier may be used as necessary to improve impact properties of general-purpose polystyrene resin used as the base resin. The impact modifier is preferably a styrene-based copolymer that has good compatibility with the base resin including polyarylene ether resin and polystyrene resin, and for example, may include at least one selected from the group consisting of a styrene-butadiene-styrene copolymer (SBS), styrene-ethylene-butylene-styrene copolymer (SEBS), styrene-butadiene copolymer (SB), styrene-isoprene copolymer (SI), styrene-isoprene-styrene copolymer (SIS), α-methylstyrene-butadiene copolymer, styrene-ethylene-propylene copolymer, styrene-ethylene-propylene-styrene copolymer, and styrene-(ethylene-butylene/styrene copolymer)-styrene copolymer.

In the present disclosure, the amount of the impact modifier may be 0 wt % to 10 wt % based on the total weight of the composition. If the amount thereof exceeds 10 wt %, moldability may decrease and it is difficult to obtain a desired heat deflection temperature.

The hydrophobic additive may include a typical nucleating agent, lubricant, and antioxidant suitable for polyarylene ether resin and polystyrene resin in the base resin, and at least one thereof may be used to improve long-term heat resistance and workability of the resin composition, but there is no particular limitation. However, in order to control metal ion leaching, which is the main characteristic of the present disclosure, limiting the use of a hydrophobic additive containing metal is regarded as important, and the composition of the present disclosure may include 1 wt % or less of the hydrophobic additive based on the total weight thereof. Application of the antioxidant or lubricant containing metal may impair the properties of the present disclosure due to metal ion leaching from the corresponding hydrophobic additive.

Both the impact modifier and the hydrophobic additive may be characterized in that they do not contain metal.

The thermoplastic resin composition may exhibit at least one of the following properties, for example, all properties:
Tensile strength of 110 MPa or more as measured according to ISO 527;
Izod notch impact strength of 8 KJ/m2 or more as measured according to ISO 180;
Heat deflection temperature of 120° C. or more as measured according to ISO 75/A (1.8 MPa);
Cation leaching of 5 ppm or less after immersion in deionized water under conditions of an area of 270 cm², 2 t, and 80° C.×168 hours.

A method of preparing a thermoplastic resin composition according to another embodiment of the present disclosure includes melt-kneading a raw material and extruding the melt-kneaded reaction mixture.

Melt-kneading the raw material may be a process of melting and mixing a base resin including polyarylene ether resin and polystyrene resin, glass fiber, an adhesion promoter or a multifunctional reactive agent, an impact modifier, and a hydrophobic additive, using a known melter or reactor, etc. Through the melt-kneading process, the resin may become fluid and the melt-kneaded reaction mixture may be formed.

Extruding the melt-kneaded reaction mixture may be a process of extruding the melt-kneaded reaction mixture to discharge the thermoplastic resin composition of the present disclosure.

The melt-kneading and extrusion processes may be performed using an extruder with 9 or more kneading blocks. The extruder is a known extruder, which includes a main hopper configured to supply a raw material, an extruder cylinder configured to communicate between the main hopper and a discharge die so that the raw material added to the main hopper is allowed to flow to the discharge die and provided with a screw inside, a discharge die configured to discharge a melt-kneaded reaction mixture, and a side feeder provided on the extruder cylinder and configured to supply an auxiliary raw material. In one embodiment, the barrel temperature of the extruder cylinder may be 230° C. to 330° C., and the rotation speed of the screw may be 100 rpm to 500 rpm.

The extrusion process may further include additional processing such as cooling, molding, etc., as necessary, but there is no particular limitation.

A better understanding of the present disclosure may be obtained through the following preparation example and test examples. These preparation example and test examples are merely set forth to illustrate the present disclosure, and are not to be construed as limiting the scope of the present disclosure.

### Preparation Example

A thermoplastic resin composition of the present disclosure was prepared by melt-kneading 50 wt % to 70 wt % of a base resin, 20 wt % to 40 wt % of glass fiber, 1 wt % to 5 wt % of an adhesion promoter, 0 wt % to 10 wt % of an impact modifier, and 0.1 wt % to 1.0 wt % of an additive.

The base resin may include polyarylene ether resin in a weight proportion of 40 to 60 and polystyrene resin in a weight proportion of 40 to 60. In consideration of easy metal ion leaching from glass fiber, the glass fiber may include a sizing agent with good wetting properties with the base resin. Also, an adhesion promoter was prepared to enhance adhesion between the base resin and the glass fiber to increase water uptake resistance at high temperatures.

Also, 0 wt % to 10 wt % of a styrene-based copolymer as an impact modifier to improve impact properties and 0.1 wt % to 1.0 wt % of a hydrophobic additive such as an antioxidant, lubricant, etc. not containing metal among typical hydrophobic additives to improve resin stability and workability, as necessary, may be melt-kneaded with the base resin, the glass fiber, the sizing agent, and the adhesion promoter. Then, the melt-kneaded reaction mixture may be extruded.

Specifically, the melt-kneading and extrusion processes were performed using a known extruder with 9 or more kneading blocks. The known extruder may include a main hopper having a large capacity as a main material supply unit, an extruder cylinder configured to communicate between the main hopper and a discharge die so that the raw material added to the main hopper is allowed to flow to the discharge die and provided with a screw inside, a discharge die configured to discharge the melt-kneaded reaction mixture, and a side feeder provided on the extruder cylinder and configured to supply an auxiliary raw material.

The components other than glass fiber were supplied through the main hopper, and glass fiber was supplied through the side feeder. Accordingly, breakage of glass fiber may be minimized, and thus the extruded product is excellent not only in mechanical properties such as impact strength, tensile strength, etc. but also in heat resistance and electrical insulating properties, and the extent of cation leaching, which is a key characteristic of the present disclosure, may be minimized.

The melt-kneading and extrusion processes may be performed at a barrel temperature of the extruder cylinder ranging from 230° C. to 330° C., preferably 240° C. to 320° C., more preferably 250° C. to 310° C. Within the above temperature range, sufficient melt kneading is possible while throughput per unit time is high, and problems such as thermal decomposition of the resin component do not occur. Also, the screw rotation speed of the extruder cylinder may be 100 rpm to 500 rpm, preferably 150 rpm to 400 rpm, more preferably 200 rpm to 350 rpm. Within the above screw rotation speed range, throughput per unit time is high and processing efficiency is excellent.

The thermoplastic resin composition of the present disclosure was prepared using components in the amounts shown in Table 1 below.

TABLE 1

| | | | | Glass fiber | | | | | | |
|---|---|---|---|---|---|---|---|---|---|---|
| | | | | (classification | | | Adhesion | | | |
| | | | | depending on sizing | | | promoter | | | |
| | Polyarylene | Polystyrene | | agent) | | | | Styrene | | |
| Component | ether | resin | | Amino | Epoxy | | Fumaric | maleic | Impact | Hydrophobic |
| (wt %) | resin | GPPS | HIPS | silane | silane | Urethane | acid | acid | modifier | additive |
| Ex. 1 | 29.5 | 29.5 | — | 30 | — | — | 5 | — | 5 | 1 |
| Ex. 2 | 34 | 25 | — | 30 | — | — | 5 | — | 5 | 1 |
| Ex. 3 | 25 | 34 | — | 30 | — | — | 5 | — | 5 | 1 |
| Ex. 4 | 27 | 27 | — | 30 | — | — | 5 | — | 10 | 1 |
| Ex. 5 | 32 | 32 | — | 20 | — | — | 5 | — | 10 | 1 |
| Ex. 6 | 31.5 | 31.5 | — | 30 | — | — | 1 | — | 5 | 1 |
| Ex. 7 | 30.5 | 30.5 | — | 30 | — | — | 3 | — | 5 | 1 |
| Ex. 8 | 25.5 | 25.5 | — | 40 | — | — | 3 | — | 5 | 1 |
| Ex. 9 | 29.5 | 29.5 | — | — | — | 30 | 5 | — | 5 | 1 |
| C. Ex. 1 | 29.5 | — | 29.5 | 30 | — | — | 5 | — | 5 | 1 |
| C. Ex. 2 | 29.5 | 29.5 | — | 30 | — | — | — | 5 | 5 | 1 |
| C. Ex. 3 | 29.5 | 29.5 | — | — | 30 | — | 5 | — | 5 | 1 |
| C. Ex. 4 | 29.5 | 29.5 | — | 30 | — | — | 5 | — | 5 | 1 |
| | | | | | | | | | | (metallic) |
| C. Ex. 5 | 32 | 32 | — | 30 | — | — | — | — | 5 | 1 |

### Test Example 1. Analysis of Hydrolysis Resistance

The hydrolysis resistance of various compounding compositions of Example 1 and other materials prepared in Preparation Example was analyzed. An ISO 178 flexural strength specimen was tested for hydrolysis resistance under harsh conditions (property degradation after 144 hours at 120° C.), and the results thereof are shown in Table 2 below.

TABLE 2

| | | Comparative | | | | Comparative | Comparative |
|---|---|---|---|---|---|---|---|
| | Example 1 | Example 1 | Comparative | Comparative | Comparative | Example 5 | Example 6 |
| | PPE/PS- | PPE/PA6- | Example 2 | Example 3 | Example 4 | PBT/ASA- | PBT/PET- |
| Classification (%) | GF30 | GF30 | PPS-GF40 | PPA-GF35 | PBT-GF30 | GF30 | GF10 |
| Hydrolysis | 91 | 59 | 48 | 82 | 86 | 31 | 13 |
| resistance | | | | | | | |
| property | | | | | | | |
| degradation | | | | | | | |

As can be seen in Table 2, the compounding composition according to Example 1 of the present disclosure showed low property degradation due to hydrolysis resistance. Since the valve cover for ACVs is continuously exposed to humid air at temperatures of 80° C. to 90° C., it must be resistant to changes in dimensions and properties due to moisture absorption, confirming that the compounding composition of the present disclosure is most suitable as a valve cover composition for ACVs among various compound candidates.

### Test Example 2. Vibration Analysis

Vibration analysis was performed for FE 2.5-generation ACV on various compounding compositions of Example 1 and other materials prepared in Preparation Example. For material properties, conditioned properties of the compounding composition of Example 1 were input, in consideration of safety factor. This is about 90% of the dry property, which is equivalent to PPE/PS-GF20 (Example 5). Here, the term “equivalent” means that the amount of glass fiber has the greatest influence on mechanical properties and even if moisture absorption is saturated, the extent of degradation in properties is not significant. The response acceleration of valve covers depending on the type of plastic material is shown in Table 3 below.

TABLE 3

| | | Comparative | Comparative |
|---|---|---|---|
| Classification | | Example 2 | Example 3 |
| (Hz) | Example 1 | (PPS-GF40) | (PPA-GF35) |
| Natural | 827 | 870 | 846 |
| frequency | | | |

Referring to Table 3, natural frequency was measured to be 870 Hz in Comparative Example 2 including polypropylene sulfide, 846 Hz in Comparative Example 3 including polyphthalamide, and 827 Hz in Example 1, which is regarded as a sufficiently large difference from ACV natural frequency (500 Hz or less). Based on results of the above test, applicability of the material of Example 1 of the present disclosure to parts was confirmed.

### Test Example 3. Analysis of Tensile Strength, Heat Deflection Temperature, Impact Strength, and Cation Leaching

The properties of the resin compositions of Examples 1 to 9 and Comparative Examples 1 to 5 prepared in Preparation Example were measured under test conditions shown in Table 4 below, and the results thereof are shown in Table 5 below.

TABLE 4

| | | Heat | | |
|---|---|---|---|---|
| | Tensile | deflection | Impact | Cation |
| | strength | temperature | strength | leaching |
| Classification | (MPa) | (° C.) | (kJ/m²) | (ppm) |
| Test | ISO 527 | ISO 75/A | ISO 180 | ICP analysis after immersion |
| conditions | (5 mm/min) | | (Notch-Izod) | in deionized water under |
| | | | | conditions of area of 270 cm², |
| | | | | 2 t, and 80° C. × 168 hours |

TABLE 5

| | Tensile | Heat deflection | Impact | Cation |
|---|---|---|---|---|
| | strength | temperature | strength | leaching |
| | (MPa) | (° C.) | (kJ/m²) | (ppm) |
| Example 1 | 141 | 142 | 11.1 | 1.6 |
| Example 2 | 143 | 144 | 11.2 | 1.6 |
| Example 3 | 127 | 128 | 11.6 | 1.6 |
| Example 4 | 128 | 125 | 13.5 | 1.7 |
| Example 5 | 113 | 120 | 10.9 | 1.5 |
| Example 6 | 117 | 122 | 8.8 | 4.4 |
| Example 7 | 140 | 141 | 9.4 | 2.1 |
| Example 8 | 153 | 144 | 12.0 | 2.7 |
| Example 9 | 146 | 142 | 11.4 | 2.8 |
| Comparative | 144 | 145 | 12.3 | 5.6 |
| Example 1 | | | | |
| Comparative | 140 | 142 | 11.2 | 3.3 |
| Example 2 | | | | |
| Comparative | 139 | 138 | 11.0 | 5.0 |
| Example 3 | | | | |
| Comparative | 144 | 143 | 11.5 | 5.7 |
| Example 4 | | | | |
| Comparative | 103 | 108 | 8.4 | 8.6 |
| Example 5 | | | | |

Target property value: Tensile strength of 110 MPa or more (vibration analysis)—target property value: heat deflection temperature of 120° C. or more (component environmental temperature safety factor 1.5 times)

The analysis results as shown in Table 5 are as follows.

Examples 1 to 3: The resin compositions in which polyarylene ether resin and polystyrene resin were used in a ratio of 25:35 to 35:25 were evaluated. All of them satisfied the target properties and achieved cation leaching of 2 ppm or less, showing excellent results corresponding to ¼ of 8 ppm that is a self-regulatory value. However, in Example 2, in which the amount of polyarylene ether resin was increased, flowability of the resin tended to slightly decrease. This decrease in resin flowability slightly lowered aesthetics of the product surface, but did not cause problems with product injection. In Example 3, in which the amount of polystyrene resin was increased, the tensile strength and heat deflection temperature decreased, but impact strength slightly increased.

In particular, based on results of detailed analysis of 1.6 ppm of cations leached in Example 1, 0.3 ppm of Na, 0.1 ppm of Mg, 0.4 ppm of Si, 0.4 ppm of K, and 0.4 ppm of Ca were detected.

Examples 4 and 5: Based on results of evaluation when using glass fiber in two different amounts with the amount of the impact modifier increased to 10 wt %, both the cation leaching and the target properties were satisfactory. Example 4, like Example 2, showed a tendency for flowability to slightly decrease during kneading.

Examples 6 to 8: For the properties depending on the amount of the adhesion promoter, the properties tended to increase to an equivalent level in the range of about 3 wt % to 5 wt %. Here, when the amount of glass fiber was increased as in Example 8, cation leaching was slightly increased. This is because the leaching of silicon (Si) constituting glass fiber increases.

Comparative Example 1: High-impact polystyrene resin (HIPS) was used in lieu of general-purpose polystyrene (GPPS) compared to Example 1. As such, cation leaching was significantly increased to 5.6 ppm in Comparative Example 1 from 1.6 ppm in Example 1, which is deemed to be due to the metal catalyst used in the HIPS polymerization process. In consideration thereof, the resin composition according to an embodiment of the present disclosure includes general-purpose polystyrene (GPPS).

Comparative Example 2: The results were compared when styrene maleic acid copolymer was used as an adhesion promoter in lieu of fumaric acid-modified polyphenylene ether compared to Example 1. In Comparative Example 2, cation leaching was 3.3 ppm, which was increased compared to Example 1 (1.6 ppm), indicating lowered compatibility between the resin and the glass fiber. As such, water uptake to the interface between the glass fiber and the resin occurred, which may be disadvantageous in view of property degradation during long-term aging. In consideration thereof, the resin composition according to an embodiment of the present disclosure includes fumaric acid-modified polyphenylene ether.

Example 9 and Comparative Example 3: The results of cation leaching depending on the type of sizing agent in glass fiber were compared. There are three major types of commercialized sizing agents: amino silane, epoxy silane, and urethane. The cation leaching was superior in the order of amino silane of Example 1 (1.6 ppm)<urethane of Example 9 (2.8ppm)<epoxy silane of Comparative Example 3 (5.0 ppm). The epoxy-based sizing treatment also satisfied the self-regulatory value, but considering the characteristics of parts, treatment with an amino silane or urethane sizing agent is preferable in the present disclosure.

Comparative Example 4: When using a metallic hydrophobic additive containing CuI, mechanical properties and heat resistance were slightly improved, but cation leaching was increased.

Comparative Example 5: When the adhesion promoter was excluded, dispersibility of glass fiber was greatly reduced, and cation leaching was greatly increased to 8.6 ppm. In general compounding compositions, it is said that the effect of increasing properties starts from about 0.5 wt % of the adhesion promoter, but in the present disclosure, the amount of the adhesion promoter was set to 1 wt % to 5 wt % in order to minimize cation leaching.

### Test Example 4. Prediction of Long-Term Thermal Aging Properties

Since heat resistance decreases with an increase in the amount of polystyrene resin (PS), it is necessary to evaluate the long-term heat resistance aging lifetime of the blend material. The effect of an organic antioxidant was verified.

The tensile strength specimen of Example 1 was evaluated as to strength after long-term aging (˜3,000 hours) at high temperatures (100° C., 110° C., 130° C., and 150° C.). The prediction model used was TTS (time-temperature superposition). Here, “TTS (time-temperature superposition)” means that the effect of time and the effect of temperature on physical behavior of a polymer are the same (superposition), and the properties experimentally measured at various temperatures are time-extended (using shift factors) at a specified temperature to predict properties, and the reliability of the predicted values is high. The results of evaluating the material lifetime at 100° C., which is the highest use temperature of parts, by accelerated deterioration based on data at 110, 130, and 150° C. are shown in FIG. 2.

As can be seen in FIG. 2, during long-term exposure to 100° C. (harsh conditions compared to a maximum temperature of 85° C.), it was possible to maintain 50% or more of properties until 670,000 hours (76.5 years) (about 60% of properties after 20 years).

As discussed above, the metal cation-reduced mPPO (alloy of PPE resin and PS resin) resin composition according to the present disclosure has excellent mechanical strength and heat resistance, and may achieve minimized metal ion leaching. Specifically, the resin composition according to the present disclosure has tensile strength of 110 MPa or more according to ISO 527, Izod notch impact strength of 8 KJ/m² or more according to ISO 180, a heat deflection temperature (HDT) of 120° C. or more according to ISO 75/A (1.8 MPa), and a metal ion (cation) leaching concentration (ICP analysis after immersion in deionized water under conditions of an area of 70 cm², 2 t, and 80° C.×168 hours) of less than 5 ppm, and may thus be applied to a fuel cell engine valve cover, etc.

As is apparent from the above description, according to the present disclosure, it is possible to reduce cost and weight compared to aluminum gravity casting products, and cation leaching is 3 ppm or less, preferably 2 ppm or less, which can greatly contribute to improving performance of a fuel cell stack. In addition, a resin composition of the present disclosure is suitable as a valve cover composition for ACVs due to dimensional stability and low property degradation under high temperature and humidity conditions. In addition, the resin composition of the present disclosure is capable of maintaining 50% or more of properties for up to about 76.5 years even under harsh conditions such as long-term exposure to high temperatures.

The effects of the present disclosure are not limited to the foregoing. It should be understood that the effects of the present disclosure include all effects that can be inferred from the description of the present disclosure.

What is claimed is:

1. A thermoplastic resin composition, comprising:
about 50 wt % to about 70 wt % of a base resin comprising polyarylene ether resin and polystyrene resin in a ratio from about 4:6 to about 6:4;
about 20 wt % to about 40 wt % of glass fiber comprising a sizing agent;
about 1 wt % to about 5 wt % of an adhesion promoter or a multifunctional reactive agent;
about 0 wt % to about 10 wt % of an impact modifier; and
about 0.1 wt % to about 1.0 wt % of a hydrophobic additive,
wherein wt % is based on a total weight of the thermoplastic resin composition.

2. The thermoplastic resin composition of claim 1, wherein the polyarylene ether resin has an intrinsic viscosity of about 0.2 dl/g to about 0.8 dl/g.

3. The thermoplastic resin composition of claim 1, wherein the polystyrene resin is general-purpose polystyrene (GPPS).

4. The thermoplastic resin composition of claim 1, wherein the glass fiber comprises an average diameter from about 3 μm to about 25 μm, and an average length from about 1 mm to about 15 mm.

5. The thermoplastic resin composition of claim 1, wherein the glass fiber is surface-modified with the sizing agent, wherein the sizing agent comprises at least one selected from the group consisting of an amino silane-based compound, a urethane compound, an epoxy silane-based compound, and combinations thereof.

6. The thermoplastic resin composition of claim 1, wherein the adhesion promoter comprises fumaric acid-modified polyarylene ether.

7. The thermoplastic resin composition of claim 1, wherein the impact modifier comprises a styrene-based copolymer.

8. The thermoplastic resin composition of claim 1, wherein the hydrophobic additive comprises at least one selected from the group consisting of a nucleating agent, a lubricant, an antioxidant, and combinations thereof.

9. The thermoplastic resin composition of claim 1, wherein the impact modifier and the hydrophobic additive do not comprise a metal component.

10. The thermoplastic resin composition of claim 1, wherein the thermoplastic resin composition comprises:
tensile strength of about 110 MPa or more as measured according to ISO 527 testing standard,
Izod notch impact strength of about 8 KJ/m² or more as measured according to ISO 180 testing standard,
a heat deflection temperature of about 120° C. or more as measured according to ISO 75/A (1.8 MPa) testing standard, and
cation leaching of about 5 ppm or less after immersion in deionized water under conditions of an area of about 270 cm², about 2 t, and about 80° C.×168 hours.

11. The thermoplastic resin composition of claim 1, wherein the polyarylene ether resin is selected from the group consisting of poly(2,6-dimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dimethoxy-1,4-phenylene ether), poly(2,6-di(chloromethyl)-1,4-phenylene ether), poly(2,6-di(bromomethyl)-1,4-phenylene ether), poly(2,6-diphenyl-1,4-phenylene ether), poly(2,6-dichloro-1,4-phenylene ether), poly(2,6-dibenzyl-1,4-phenylene ether), and poly(2,5-dimethyl-1,4-phenylene ether).

12. The thermoplastic resin composition of claim 1, wherein the polyarylene ether resin has a number average molecular weight of about 10,000 g/mol to about 100,000 g/mol.

13. The thermoplastic resin composition of claim 1, wherein the polystyrene resin has a flow index of about 2 g/10 min to about 20 g/10 min as measured at 200° C. under 5 kg according to ASTM D1238.

14. The thermoplastic resin composition of claim 1, wherein the glass fiber comprises silica (SiO2) in a weight proportion of about 50% to about 70%.

15. The thermoplastic resin composition of claim 1, wherein the glass fiber is surface-modified with a sizing agent comprising an amino silane-based compound or a urethane compound to improve wetting properties and mechanical strength.

16. A method of preparing a thermoplastic resin composition, comprising:
melt-kneading a raw material producing a melt-kneaded reaction mixture; and
extruding the melt-kneaded reaction mixture,
wherein the raw material comprises from about 50 wt % to about 70 wt % of a base resin comprising polyarylene ether resin and polystyrene resin in a ratio from about 4:6 to about 6:4, about 20 wt % to about 40 wt % of glass fiber comprising a sizing agent, about 1 wt % to about 5 wt % of an adhesion promoter or a multifunctional reactive agent, about 0 wt % to about 10 wt % of an impact modifier, and about 0.1 wt % to about 1.0 wt % of a hydrophobic additive.

17. The method of claim 16, wherein:
the melt-kneading the raw material and the extruding the melt-kneaded reaction mixture are performed using an extruder with 9 or more kneading blocks,
wherein the extruder comprises a main hopper and an extruder cylinder, wherein the main hopper is configured to supply a raw material to the extruder cylinder,
wherein the extruder cylinder comprises a screw and is configured to communicate between the main hopper and a discharge die so that the raw material added to the main hopper is allowed to flow to the discharge die and melt-knead a reaction mixture,
wherein the discharge die is configured to discharge the melt-kneaded reaction mixture from the extruder, and
wherein a barrel temperature of the extruder cylinder is from about 230° C. to about 330° C., and a rotation speed of the screw is from about 100 rpm to about 500 rpm.

18. The method of claim 17, wherein the extruder cylinder further comprises a side feeder configured to supply an auxiliary raw material to the extruder cylinder.

19. The method of claim 16, further comprising cooling the extruded melt-kneaded reaction mixture to form solid pellets.

20. The method of claim 16, wherein the extruder comprises a discharge die configured to discharge the melt-kneaded reaction mixture at a controlled rate to ensure uniformity of the final product.
